(19) United States
(12) Patent Application Publication
(10) Pub. No.: US 2006/0235166 A1
(43) Pub. Date: Oct. 19, 2006

(54) Polymer networks

(76) Inventors: Shik Chi Edman Tsang, Reading (GB); Peter Michael Jenkins, Reading (GB)

Correspondence Address: NIXON & VANDERHYE, PC, 901 NORTH GLEBE ROAD, 11TH FLOOR, ARLINGTON, VA, 22203, US

(21) Appl. No.: 10/553,060

(22) PCT Filed: Apr. 22, 2004
(86) PCT No.: PCT/GB04/01752

§ 371 Date: Oct. 12, 2005

(30) Foreign Application Priority Data
Apr. 22, 2003 (GB) 0309010.7

(51) Int. Cl. C08F 8/00; B01J 31/00

(52) U.S. Cl. 525/366; 525/330.3; 502/159

(57) ABSTRACT

The present invention provides catalytic polymer networks containing an active atom of tin, silicon or germanium having a high activity with reduced toxicity due to reduced leaching of the active atom from the polymer.

### FIELD OF THE INVENTION

The present invention is concerned with the polymer networks and processes for their production. More specifically, the present invention is concerned with polymer networks containing tin, silicon or germanium.

### BACKGROUND OF INVENTION

Soluble forms of trialkyltin hydrides have been employed as reagents in the synthesis of fine chemicals for decades despite their associated (non-regenerable) and toxic problems. It is because the Sn—H bond is homolytically very labile such that many radical assisted organic syntheses based on these reagents have been developed. The toxicity of trialkyltin compounds is strongly dependent on the nature and length of the alkyl chains (inversely dependent on alkyl chain length). Their toxcity has been widely debated and has hindered the introduction of tin hydride chemistry to the synthesis of pharmaceutical products for human consumption. Many potential replacements have been investigated over the past two decades but only few alternatives such as (Me₃Si)₃SiH and Bu₃GeH, which display similar chemical properties to the trialkyltin hydrides, have met with any degree of success. Nevertheless, the superiority, versatility and selectivity at lower available costs sustain trialkyltin hydrides as important industrial reagents. It is noted the recent re-introduction of tributyltin hydride chemistry for drug synthesis denotes the importance & unique synthetic roles of these reagents.

For practicality, other attempts have been focussed to immobilise trialkyltin hydride analogues, and hence combine the favourable reactivity associated with the tin and the separation capabilities of solid tethered reagents/catalysts. Most attention in this area has focused on insoluble cross-linked polystyrene supports. These have proven to be more successful than most inorganic supports, although active tin hydride loadings struggle to reach values above about 1.4 mmol g⁻¹ and leaching problems cannot be completely eliminated. Few tin hydrides immobilised onto non-styrenic polymer supports have been reported. The key point to note concerning all previous support methods, is that the tin centre is only bound by a single covalent Sn—C bond to the polymer. Cleavage of this linkage, by any given mechanism such as beta-elimination, will inevitably allow product contamination with the soluble tin compounds.

### SUMMARY OF THE INVENTION

In a first aspect of the present invention there is provided a polymer comprising a structural unit (1) 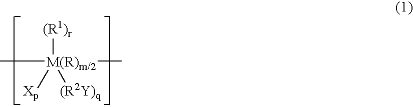
wherein R is individually selected from divalent hydrocarbon radicals;
R¹ is selected from the group consisting of monovalent hydrocarbon radicals, organic polymers and inorganic polymers;
R² is individually selected from divalent hydrocarbon radicals;
M is a tin, silicon or germanium atom, preferably tin or silicon, more preferably tin;
X is selected from H, Cl, Br and I;
Y is selected from H, Cl, Br and I;
m is an integer of 1 or 2;
p is an integer of 1 or 2;
q is an integer of 1 or 2;
r is an integer of 0 or 1; and,
wherein m+p+q+r=4.

In a second aspect of the present invention there is provided a polymer comprising a structural unit (2) 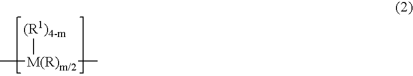
wherein R is individually selected from divalent hydrocarbon radicals;
R¹ is selected from the group consisting of monovalent hydrocarbon radicals, H, Cl, Br, I, organic polymers and inorganic polymers;
M is a tin, silicon or germanium atom, preferably tin or silicon, more preferably tin; and,
m is an integer of 1-4.

In a further aspect of the present invention, there is provided a process for the production of a polymer comprising a structural unit (2), comprising reacting a diGrignard reagent having the formula (3)
XM′(R)M′X (3)
wherein X is individually selected from the group consisting of Cl, Br and I;
M′ is individually selected from the group consisting of Group II metals, Group XI metals, Group XII metals and mixtures thereof; and,
R is selected from divalent hydrocarbon radicals;
with a compound having the formula (4)
R¹ₐMX′_{b} (4)
wherein R¹ is selected from the group consisting of monovalent hydrocarbon radicals, H, organic polymers and inorganic polymers;
M is a tin, silicon or germanium atom, preferably tin or silicon, more preferably tin;
X is individually selected from the group consisting of Cl, Br and I;
X′ is individually selected from the group consisting of Cl, Br and I;
a is an integer of 0-2; and,
b is an integer of 2-4.

In a further aspect of the present invention, there is provided a process of production of a polymer comprising a structural unit (1), wherein X and Y are selected from Cl, Br and I, comprising reacting a compound having formula (2) with a compound selected from a chlorinating agent, a brominating agent and an iodinating agent.

In a further aspect of the present invention, there is provided a process of production of a polymer comprising a structural unit (1), wherein X and Y are H, comprising reacting a polymer comprising a structural unit (1), wherein X and Y are selected from Cl, Br and I, with a reducing agent that is a hydride source.

The polymers of the present invention preferably comprise polymer networks. The polymers and polymeric networks according to the present invention are organometallic composites. The inorganic component is tin, silicon or germanium, and the organic being the divalent and monovalent hydrocarbon moieties interconnecting the inorganic component.

According to a further aspect of the present invention, there is provided a polymer comprising the structural unit (5)
(HSi)ₙ (5)
wherein n is an integer.

In compounds having a unit (5), preferably n is an integer of 3-1000000, more preferably 10-100000, more preferably 50-50000, more preferably 200-10000.

According to a further aspect of the present invention, there is provided a process for the production of a polymer comprising a structural unit (5)
(HSi)ₙ (5)
wherein n is an integer;
comprising reducing a compound having the formula (6)
HSiX″₃ (6)
wherein X″ is individually selected from the group consisting of Cl, Br and I, preferably Cl.

The reducing agent used to produce compound (5) is preferably an ionic metal containing compound. Particularly preferred compounds include ionic metal-hydrocarbon pairs, preferably selected from the group consisting of ionic Group I, II, XI and XIII metal-hydrocarbon compounds. Preferably, the metal forms the cationic moiety and the hydrocarbon forms the anionic moiety.

Preferred metals used in the ionic Group I, II, XI and XIII metal-hydrocarbon compounds include Li, Na, K, Mg, Ca, Cu, Hg and Zn.

Preferred anionic hydrocarbons include cyclohexenyl, benzyl, phenylethyl and phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl and biphenylyl anions. A particularly preferred reducing agent is sodium naphthalenide.

The present invention provides or may be used to construct catalyst systems. The fundamental principle is based on building a catalyst that contains the active site as part of the polymer or polymeric network backbone. As used herein, the term “catalyst” refers to a compound that speeds a chemical reaction or causes it to occur. The catalysts of the present invention are formally organometallic compounds. Certain types of the organometallic compounds of the invention will require “activation” prior to being catalytically active. Other organometallic compounds of the invention will be “activator-free catalysts” and will not require activation prior to being catalytically active.

The catalytic polymers of the present invention are preferably hydrogenation catalysts. For example, they may be used to hydrogenate unsaturated systems such as aldehydes, ketones and olefins. Alternatively, they may be used in the hydrogenation of halogenated hydrocarbons via a halogen displacement reaction.

A polymer according to the present invention preferably comprises one or both of the following structures 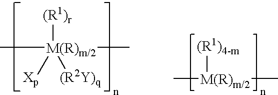
wherein R, R¹, R², M, X, Y, m, p, q and r are as defined above, and wherein n is an integer. Preferably, n is an integer of 10-100000, more preferably 50-50000, more preferably 200-10000. Preferably, n is of a magnitude capable of rendering the polymer substantially insoluble in organic solvents.

The polymers of the present invention are preferably substantially insoluble in organic solvents. Thus, the production of heterogenous catalysts is facilitated.

In the above structures and formulas (1)-(6):

R is preferably selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ alkarylenediyl and C₅₋₃₀ arylenediyl, any of which may be optionally substituted with one or more heteroatoms in the carbon backbone.

R is more preferably selected from the group consisting of C₁₋₁₅ alkanediyl, C₂₋₁₅ alkenediyl, C₂₋₁₅ alkynediyl, C₄₋₂₀ cycloalkanediyl, C₄₋₂₀ cycloalkenediyl, C₅₋₂₀ cycloalkynediyl, C₇₋₂₀ alkarylenediyl and C₆₋₂₀ arylenediyl, any of which may be optionally substituted with one or more heteroatoms in the carbon backbone.

R is more preferably selected from the group consisting of straight chain C₁₋₁₅ alkanediyl, C₂₋₁₅ alkenediyl and C₆₋₁₅ alkarylenediyl.

Most preferably, R is selected from 1,6-hexylene, 1,8-octylene, 1,10-decylene and 1,12-dodecylene.

Preferably substantially all groups R are the same.

The term “alkanediyl” refers to a straight or branched saturated divalent hydrocarbon radical having the number of carbon atoms indicated.

The terms “alkenediyl” and “alkynediyl” refer to straight or branched, unsaturated divalent hydrocarbon radicals. An “alkenediyl” is characterized by a carbon-carbon double bond and an “alkynediyl” is characterized by a carbon-carbon triple bond.

The term “cycloalkanediyl” refers to a cyclic saturated divalent hydrocarbon radical having the number of carbon atoms indicated.

The terms “cycloalkenediyl” and “cycloalkynediyl” refer to cyclic unsaturated divalent hydrocarbon radicals. A “cycloalkenediyl” is characterized by a carbon-carbon double bond and a “cycloalkynediyl” is characterized by a carbon-carbon triple bond.

The term “arylenediyl” refers to a divalent unsaturated aromatic carbocyclic radical having one or two rings.

The term “alkarylenediyl” refers to a divalent unsaturated mono- or di-alkyl-substituted aromatic carbocyclic radical having one or two rings.

R¹ is preferably selected from the group consisting of C₁₋₂₀ alkyl, C₁₋₂₀ alkoxy, C₂₋₂₀ alkenyl, C₂₋₂₀ alkynyl, C₃₋₃₀ cycloalkyl, C₃₋₃₀ cycloalkenyl, C₄₋₃₀ cycloalkynyl, C₇₋₃₀ alkaryl, C₅₋₃₀ aryl, C₅₋₃₀ aryloxy, any of which may be optionally substituted with one or more heteroatoms in the carbon backbone, organic and inorganic polymers.

R¹ is more preferably selected from the group consisting of C₁₋₁₅ alkyl, C₁₋₁₅ alkoxy, C₂₋₁₅ alkenyl, C₂₋₁₅ alkynyl, C₃₋₂₀ cycloalkyl, C₃₋₂₀ cycloalkenyl, C₄₋₂₀ cycloalkynyl, C₇₋₂₀ alkaryl, C₆₋₂₀ aryl, C₆₋₂₀ aryloxy, any of which may be optionally substituted with one or more heteroatoms in the carbon backbone, organic and inorganic polymers.

R¹ is more preferably selected from the group consisting of straight chain C₁₋₁₀ alkyl, C₁₋₁₀ alkoxy, C₂₋₁₀ alkenyl, C₆₋₁₂ aryl, C₆₋₁₂ aryloxy and organic polymers.

Most preferably, R¹ is selected from the group consisting of methyl, ethyl, propyl, butyl, hexyl, cyclohexyl, octyl, nonyl, dodecyl, eicosyl, norbornyl and adamantyl, vinyl, propenyl and cyclohexenyl, benzyl, phenylethyl and phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl, biphenylyl, methoxy, ethoxy, propoxy, butoxy, pentoxy, hexoxy, phenoxy, 1,2-dimethylbutoxy, most preferably phenyl and phenoxy.

Each R¹ may be the same or different, preferably the same.

The term “alkyl” refers to a straight or branched saturated monovalent hydrocarbon radical having the number of carbon atoms as indicated.

The term “alkoxy” refers to the group “alkyl-O-”, where alkyl is as defined above.

The term “alkenyl” refers to a straight or branched unsaturated monovalent hydrocarbon radical having the number of carbon atoms as indicated and the distinguishing feature of a carbon-carbon double bond.

The term “alkynyl” refers to a straight or branched unsaturated monovalent hydrocarbon radical having the number of carbon atoms as indicated and the distinguishing feature of a carbon-carbon triple bond.

The term “cycloalkyl” refers to a cyclic saturated monovalent hydrocarbon radical having the number of carbon atoms as indicated.

The terms “cycloalkenyl” and “cycloalkynyl” refer to cyclic unsaturated monovalent hydrocarbon radicals. A “cycloalkenyl” is characterized by a carbon-carbon double bond and a “cycloalkynyl” is characterized by a carbon-carbon triple bond.

The term “aryl” refers to a monovalent unsaturated aromatic carbocyclic radical having one or two rings, such as phenyl, naphthyl, indanyl or biphenyl, or to a monovalent unsaturated aromatic heterocyclic radical such as quinolyl, dihydroisoxazolyl, furanyl, imidazolyl, pyridyl, phthalimido, thienyl and the like.

The term “aryloxy” refers to the group “aryl-O—”, where aryl is as defined above.

A non-limiting list of organic and inorganic polymers that R¹ may comprise includes polyacetals, polyamides, polyimides, polyesters, polycarbonates, polyamide-imides, polyamide-esters, polyamide ethers, polycarbonate-esters, polyamide-ethers, polyacrylates; elastomers such as polybutadiene, copolymers of butadiene with one or more other monomers, butadiene-acrylonitrile rubber, styrene-butadiene rubber, polyisoprene, copolymers of isoprene with one or more other monomers, polyphosphazenes, natural rubber, blends of natural and synthetic rubber, polydimethylsiloxane, copolymers containing the diphenylsiloxane unit; polyalkylmethacrylates, polyethylene, polypropylene, polystyrene, polyvinylacetate; polyvinylalcohol, polyvinylchloride, silica and alumina. Such polymers preferably comprise part of a support for the polymer of the present invention.

R² is preferably individually selected from the same groups as R, and may be substantially the same or different.

X is preferably individually selected from the group consisting of Br, I and H, most preferably Br and H.

Y is preferably individually selected from the group consisting of Br, I and H, most preferably Br and H.

X′ is preferably Cl.

For structure (1), m is preferably 2. For structure (2), m is preferably 3 or 4, more preferably 3.

p is preferably 1.

q is preferably 1.

Where p and q are 1, r is preferably 0.

M′ is preferably selected from magnesium, calcium, mercury and copper, most preferably magnesium.

a is preferably 0 or 1.

b is preferably 3 or 4.

Preferred chlorinating, brominating and iodinating agents are the respective molecular halogens, i.e., Cl₂, Br₂, I₂.

Preferred reducing agents used in the process for the production of a polymer comprising a unit (1) include the borohydrides, aluminium hydrides and boranes. Exemplary reducing agents include Lithium aluminium hydride, sodium borohydride, sodium hydride, boranes, selectride, lithium borohydride, sodium cyanoborohydride, sodium naphthelenide, DIBAL-H and REDAL-H.

The reduction reaction of the substrate species is preferably facilitated with a radical intitiator. Exemplary initiators include 2,2′-azobisisobutyronitrile (AIBN), benzoyl peroxide, tert-butyl peracetate, peracetic acid, tert-amyl peroxybenzoate, tert-butylperoxide, cyclohexanone peroxide and the like.

Compounds having a structural unit (1), more preferably comprise a structural unit (7) and/or (8) 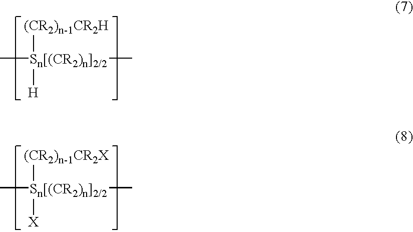
wherein R is individually selected from the group consisting of H, methyl
and propyl, preferably H;
X is Cl, Br or I; and,
n is an integer of 1-20, preferably 1-12, more preferably 6, 8, 10, or 12.

Compounds having a structural unit (2), more preferably comprise a structural unit (9) and/or (10) 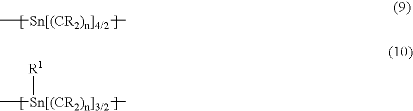
wherein R is individually selected from the group consisting of H, methyl and propyl, preferably H;
R¹ is selected from the group consisting of C₆₋₁₀ aryl and C₆₋₁₀ aryloxy, preferably phenyl and phenyloxy; and,
n is an integer of 1-20, preferably 1-12, more preferably 6, 8, 10, or 12.

Molecular weights of the polymers according to the present invention are preferably in the range of 100-10000000, more preferably in the range of 1000-1000000, more preferably in the range 10000-100000.

In a particularly preferred embodiment of the present invention, polymeric networks containing tin hydrides are produced. Such networks are preferably prepared in a multi-step process.

In a preferred process, a diGrignard reagent is prepared via a known method from a species such as an n-dihaloalkane, wherein n is the number of carbon atoms in the alkane. For example 1,12-dibromododecane and 1,6-dibromodohexane are preferred reagents. The diGrignard reagent is preferably prepared using magnesium metal in aprotic solvents, for example etheric solvents such as diethyl ether, THF and the like.

In a first stage, the diGrignard is preferably reacted with a tin, silicon or germanium halide, for example a tin chloride based species such as SnCl₄, PhSnCl₃ or PhOSnCl₃. This forms a polymeric network that can then be treated in a second step with a halogenating agent, for example, a molecular halogen such as bromine or iodine, to remove the phenyl groups and/or to introduce tin, silicon or germanium halide functionalities, e.g. tin bromide functionalities into the network. In a third step, or a step concurrent with the second step, the tin, silicon or germanium halide groups may then be reduced with a hydride donor reducing agent, for example, sodium borohydride, to form the corresponding tin, silicon or germanium hydride groups.

Preferred solvents for the multi-step process include ethers, for example diethyl ether, tetrahydrofuran and diphenyl ether. Preferably the multi-step process is carried out under substantially dry conditions with dry solvents. Further, the above mentioned processes may be carried out under an inert atmosphere, for example, nitrogen or argon.

The polymeric network produced may be used for catalysis. Both the polymers and the polymeric networks are preferably insoluble, and are preferably capable of swelling in organic solvents. As the solvents used for swelling, there may be mentioned, for example, hydrocarbon solvents such as benzene and toluene; ether type solvents such as diethyl ether, tetrahydrofuran, diphenyl ether, anisole and dimethoxybenzene; halogenated hydrocarbon solvents such as methylene chloride, chloroform and chlorobenzene; ketone type solvents such as acetone, methyl ethyl ketone and methyl isobutyl ketone; alcohol type solvents such as methanol, ethanol, propanol, isopropanol, n-butyl alcohol and tert-butyl alcohol; nitrile type solvents such as acetonitrile, propionitrile and benzonitrile; ester type solvents such as ethyl acetate and butyl acetate; carbonate type solvents such as ethylene carbonate and propylene carbonate; and the like. These may be used singly or two or more of them may be used in admixture.

Due to the highly cross-linked nature of the networks, they are considered to have greater mechanical robustness over known insoluble polymers. Further, due to the flexibility of the material, they are more durable than highly rigid inorganic supports such as high surface area silicas that may be crushed.

Some of the advantages attributable to various of the polymer networks according to the present invention include facilitated separation of the polymers from the polymer production mixture, the reduction of leaching of tin from the reagent and catalyst materials, reduced toxicity of the polymers, superior mechanical, thermal and chemical stability over equivalent prior art catalysts, and a high selectively of reactions.

### BRIEF DESCRIPTION OF THE FIGURES

By way of example only, the benefits of the invention will now be illustrated by reference to the accompanying drawings in which:

FIG. 1 graphically represents the catalytic activity of polymeric tin hydride for polymer tin network 12b prepared according to Example 4 wherein the left hand vertical axis of the graph is a scale of the percentage activity and the right hand vertical axis is a scale for the activity in terms of mmolg⁻¹;

FIG. 2 graphically represents the selectivity of polymeric tin hydride for polymer tin network 12b; and

FIG. 3 graphically represents the swelling properties of polymeric tin network 11 prepared according to Example 1.

### DETAILED DESCRIPTION OF THE INVENTION

The invention will now be illustrated by the following Examples which are not intended to limit the scope of protection obtained.

### EXAMPLES

The basic experimental procedure is similar to that employed for the synthesis of a fluorous tin hydride used by Dennis P. Curran [Dennis P. Curran, Masahide Hoshino, Journal of Organic Chemistry, 1996, Vol 61, p6480-6481]. A diGrignard is prepared and allowed react with a tin based species preferably containing three or more tin chloride bonds. At the end of the reaction unreacted tin chloride bonds may be converted to tin hydroxyls and the unreacted Grignard functionalities may be converted to carbon-hydrogen groups by the addition of either saturated ammonium chloride or 2.0 molar hydrochloric acid. The samples are preferably filtered and washed with de-ionised water to remove any acid and then with diethyl ether to remove any soluble polymers and very small (soluble) fragments of the polymeric network. The diethyl ether is allowed to evaporate from the samples in air before they are placed in the oven at 100° C. until dry (about 2 h), the samples are then treated again with 2.0 molar hydrochloric acid and a small amount of diethyl ether. The diethyl ether is used to swell the network and release any magnesium or magnesium dihalide particles. It is also believed that this process helps to purify the samples by the removal of any tin oxide character although this has not been confirmed. Tin oxide character arises due to the presence of tin hydroxyl groups that can undergo condensation giving tin-oxygen-tin bridging units.

For all methods, all solvents are distilled, dried and degassed. All glassware, stirrer bars, and anti-bumping granules are dried in an oven and the apparatus is set up whilst still hot, under a purge of nitrogen. The formation of the diGrignards was always initiated with application of a combination of anti-bumping granules and iodine vapour treatment to the magnesium. At the end of the reaction all materials were treated with a similar work-up procedure; The solids were filtered and washed with de-ionised water or methanol and diethyl ether before the diethyl ether was allowed to evaporate in air at room temperature from the solid, the materials were then dried at 100° C., cooled and treated with 2.0 molar hydrochloric acid and diethyl ether, then washed with de-ionised water and dried at 100° C. under vacuum.

Reagents

Phenyltin trichloride was prepared as follows; bromobenzene (Aldrich) in diethyl ether (Fisher) was added to iodine (BDH) pre-treated magnesium turnings (Aldrich). The reaction was initiated with gentle warming and turned deep red in colour shortly after the appearance of the magnesium salt. The Grignard reagent was stirred at room temperature for 1 h before the solution was cooled in a dry ice/acetone (BDH) bath and tin (IV) chloride (Lancaster) in diethyl ether added. This was heated under reflux overnight and at room temperature, saturated ammonium chloride (BDH) added. The white solid was collected by filtration, and the organic layer was washed with water before the solvent was removed. All solids were combined and recrystallised from chloroform (Fisher) to yield the pure Ph4Sn. Tetraphenyltin was reacted with tin (IV) chloride in a 1:3 molar ratio at 150° C. for 3 h, the phenyltin trichloride was then vacuum distilled to yield the pure product as in accordance with the literature. [Henry Gilman and Lewis A. Gist, Jr, Journal of Organic Chemistry, 1957, 22, 368] Proton NMR spectroscopy revealed the product to be 96% pure, with the only observable impurities being partially hydrolysed product although this is most likely to have occurred during the preparation of the sample for NMR spectroscopy. (spectrum recorded in CDCl₃ (Cambridge Isotope Laboratories)) The diGrignard reagents were always prepared from their corresponding dihalide, 1,12-dibromododecane (Acros), 1,10-diiododecane (Acros), 1,8-dibromooctane (Acros), 1,6-dibromohexane (Lancaster). 2.0 molar hydrochloric acid was diluted from concentrated hydrochloric acid (Fisher). Other reagents, bromine (Aldrich), sodium borohydride (Aldrich), ethanol (BDH), methanol (Fisher), 1-butanol (Acros), 1-iodooctane (Lancaster), octane (Aldrich), cyclohexane (Fisher).

### Example 1

Method A; Synthesis of Sn((CH₂)ₙ)_{4/2} (11) Type Polymeric Networks

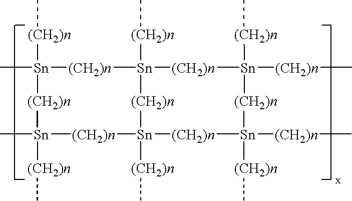

Typically about 10% of X(CH₂)ₙX, where X═Br or I and n=6,8,10 or 12 in diethyl ether was added to the magnesium that had been pre-treated with iodine vapour. The reactions were stirred at room temperature, after about 1 minute of stirring the reactions self initiated and the remaining dihalide was slowly added at room temperature with vigorous stirring. After the final addition of the dihalides, the diGrignards were stirred for 1 h to ensure the complete formation of the reagent. The diGrignards were then cooled in a dry ice/acetone bath before tin (IV) chloride was added directly to the stirred solution, this was allowed to warm to room temperature and then heated under reflux for 10 minutes. The solution containing the polymeric networks was then cooled to room temperature and saturated ammonium chloride added. Typically, 0.350 g, 14.6 mmol Mg, 1.70 g, 6.97 mmol Br(CH₂)₆Br, and 0.41 ml, 0.91 g, 3.5 mmol SnCl₄ were used for the synthesis of Sn((CH₂)₆)_{4/2}.

Preparation of Sn((CH₂)₆)_{4/2} (11) Polymeric Networks

The following polymeric networks (Sn((CH₂)₆)_{4/2}) (11) shown in Table 1 were prepared by ‘method A’ to establish the best synthesis conditions for activity and resistance to bromine degradation.

TABLE 1

| Polymeric | Assumed diGrignard | | Mg | SnCl₄ in |
|---|---|---|---|---|
| network | yield in % | Br(CH₂)₆Br in g | in g | ml |
| A1 | 120 | 1.42 | 0.29 | 0.41 |
| | (excess of Sn—Cl bonds) | | | |
| A2 | 110 | 1.55 | 0.32 | 0.41 |
| A3 | 100 | 1.70 | 0.35 | 0.41 |
| A4 | 90 | 1.89 | 0.39 | 0.41 |
| A5 | 80 | 2.13 | 0.44 | 0.41 |
| | (excess of RMgX | | | |
| | groups) | | | |

To samples of each network, 60 μl bromine was added in diethyl ether (10 ml) and stirred until the solution was clear. The solid were washed twice with diethyl ether (2×10 ml) and the soluble fraction collected. The polymer was treated with sodium borohydride (0.200 g, 5.26 mmol) in ethanol (20 ml) and heated under reflux overnight. This was then washed with methanol (4×10 ml) and 1-butanol (2×5 ml) to be certain of removing any traces of the sodium borohydride. 1-Butanol (10 ml), 1-iodooctane (200 μl, 1.38 mmol) and 2,2-azobisisobutyronitrile (AIBN) were added and the reaction heated to 80° C. overnight. The polymeric networks were filtered and the liquid collected for gas chromatography analysis. Samples were also sent for ICP analysis to determine the degree of tin contamination.

### Table 2

Resistance of (11) to degradation by bromine.

| Polymeric network | Mass used, mmol of tin | % loss* |
|---|---|---|
| A1 | 0.4050 g, 1.41 mmol | 89 |
| A2 | 0.4059 g, 1.41 mmol | 75 |
| A3 | 0.3215 g, 1.12 mmol | 39 |
| A4 | 0.3373 g, 1.18 mmol | 49 |
| A5 | 0.3684 g, 1.28 mmol | 47 |

*percent loss relative to 1 molar equivalent of Br₂.

In general, it can be observed from Table 2 that a greater incorporation of the organic phase results in a material that possesses an enhanced resistance to chemical breakdown as a result of bromination.

TABLE 3
Activity of the polymeric tin hydride (11).

| Polymeric network | Active tin as SnH in % | Active SnH in mmol g⁻¹ |
|---|---|---|
| A1 | No data | No data |
| A2 | No data | No data |
| A3 | 41.3 | 1.43 |
| A4 | 50.2 | 1.74 |
| A5 | 32.9 | 1.14 |

The results in Table 3 show that the material prepared assuming a 90% yield of diGrignard (ie 1/0.9=1.11 times excess) was found to have the best active tin hydride content.

### Example 2

Method B; Synthesis of PhSn((CH₂)ₙ)_{3/2} (11′) type polymeric networks.

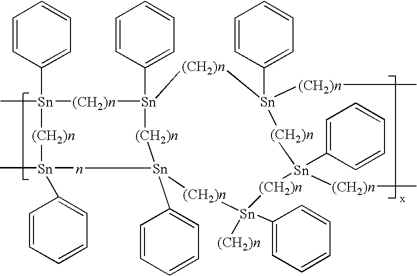

Typically about 10% of X(CH₂)ₙX, where X═Br or I and n=6,8,10 or 12 in diethyl ether was added to the magnesium that had been pre-treated with iodine vapour, and the diGrignards formed as described according to method A. Interestingly the diGrignards formed a biphasic mixture with a pale brown layer under a clear layer in the case of the shorter hydrocarbon linkers, n=6 and 8. These diGrignards were cooled in a dry ice/acetone bath and phenyltin trichloride in diethyl ether added, this was then heated under reflux for 30 min before saturated ammonium chloride was added at room temperature. This gave a rubbery white material contaminated with magnesium that was later removed with 2.0 molar hydrochloric acid. Typically, 0.589 g, 24.2 mmol Mg, 2.890 g, 11.8 mmol Br(CH₂)₆Br, 1.97 g, 6.5 mmol PhSnCl₃ for the synthesis of PhSn((CH₂)₁₂)_{3/12}.

### Example 3

Method C; Alternative Synthesis of PhSn((CH₂)₁₂)_{3/2} (11′) Polymeric Network.

The fundamental principle of this methodology is that the diGrignard is added to the tin compound causing tin atom cross-linking earlier during the network formation. The major advantages of this method are that a minimum of magnesium turnings become entrapped inside the polymeric network, and that cross-linking occurs at the beginning of the addition rather than at the end, hence the material is of better structural integrity.

Decomposition of the phenyltin trichloride in the presence of magnesium metal is also substantially avoided by this method. The diGrignard is prepared in a minimum of solvent and is added to the phenyltin trichloride that is dissolved also in a minimum of solvent, the use of a minimum of solvent gives rise to much improved yields. The elimination of magnesium from the material is advantageous for organic synthesis as alkali metals can cause coupling of tin halides (R₃SnX) that are present when the tin hydride is used catalytically.

A 1.67 times excess of diGrignard was used as to add the diGrignard in a suitable excess (the material produced from the reaction using a 1.11 times excess of diGrignard became very brittle after drying, presumably due to the presence of significant numbers of tin-oxygen-tin bridges arising from hydroxyl groups).

1,12-dibromododecane in a minimum of diethyl ether was added to magnesium that had been pre-treated with iodine vapour in a shlenck flask. The diGrignard was stirred at room temperature for 2 h before it was added to phenyltin trichloride also in a minimum of diethyl ether. The white solid was heated under reflux for 2 h without stirring before the material was filtered and washed with de-ionised water and diethyl ether. The network was dried at 100° C. (this caused a hardening of the network) then washed in 2.0 molar hydrochloric acid with a little diethyl ether followed by water and diethyl ether and dried at 100° C. in a vacuum oven. Typically, 0.281 g, 11.7 mmol magnesium, 1.83 g, 5.58 mmol 1,12-dibromododecane, 0.675 g, 2.23 mmol phenyltin trichloride.

### Example 4

Synthesis of XSn(R)_{2/2}RH, (12) where X═Br (a) or H (b) type polymers

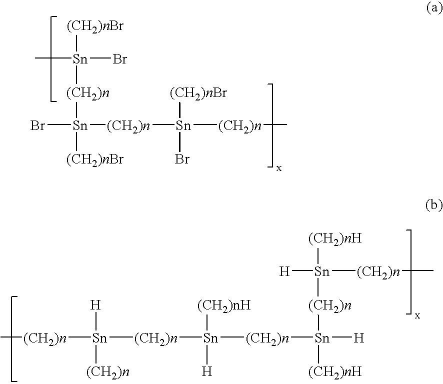

Polymeric networks of the form Sn(R)_{4/2} (11) (R═(CH₂)ₙ, n=6, 8, 10 or 12) were swollen in diethyl ether and treated with bromine. Once the solutions were no longer coloured, the polymers were washed with diethyl ether and treated with sodium borohydride in ethanol at 80° C. for 6 h. The polymers were then extensively washed with methanol (usually 4 times) and then with 1-butanol (usually 2 times).

Feasibility Test for Catalytic Use of the Polymeric Networks

PhSn((CH₂)₁₂)_{3/2} (11′) (0.400 g, 0.892 mmol) was swelled in diethyl ether (10 ml) and bromine (46 μl, 143 mg, 0.897 mmol) added. This was stirred overnight, washed with diethyl ether (2×10 ml), and sodium borohydride (0.200 g, 5.26 mmol) in ethanol (20 ml) added and stirred overnight. The tin hydride was washed thoroughly with diethyl ether, methanol and 1-butanol before 1-butanol (10 ml), 1-iodooctane (200 μl, 1.38 mmol) and 2,2-azobisisobutyronitrile (AIBN) were added. This was heated to 80° C. for 28.5 h before the reaction was cooled, the catalyst filtered out and washed with 1-butanol. 23 ml was collected and this was analysed by gas chromatography to obtain the active tin hydride content by the amount of octane produced, and by ICP (inductive coupling plasma) to determine the degree of tin leaching.

The GC results revealed that 0.574 mmol of n-octane had been produced, 0.892 mmol of catalyst had been initially used, however, material is lost during the bromination step due to slight decomposition of the network, and some catalyst was lost during the washing stages. The amount of catalyst recovered was therefore used for the activity calculations. 0.618 mmol of catalyst was recovered, this gives the material a tin hydride activity 92.8%, and an active tin hydride concentration of 2.50 mmol g⁻¹. The most active heterogeneous tin hydride in the literature is quoted at 1.4 mmol g⁻¹. The solution was found to contain levels of tin that were below the detection limits of the ICP (inductive coupling plasma) instrument.

Very similar experiments were performed for the PhSn((CH₂)₁₂)_{3/2} network. Samples were prepared according to ‘method B’ as shown in Table 4.

TABLE 4

| | Assumed yield of | | | |
|---|---|---|---|---|
| | Grignard | Br(CH₂)₁₂Br | | PhSnCl₃ |
| Experiment | yield % | in g | Mg in g | in g |
| B1 | 120 | 0.915 | 0.1406 | 0.675 |
| | (excess of Sn—Cl | | | |
| | bonds) | | | |
| B2 | 110 | 0.998 | 0.1534 | 0.675 |
| B3 | 100 | 1.098 | 0.1688 | 0.675 |
| B4 | 90 | 1.220 | 0.1875 | 0.675 |
| B5 | 80 | 1.373 | 0.2109 | 0.675 |
| | (excess of RMgX | | | |
| | groups) | | | |

To samples of each of the polymeric networks in diethyl ether (10 ml), bromine at a ratio of 0.839, bromine to tin, was added at room temperature and stirred until the solution was clear. During the bromination, any magnesium in the samples was removed, presumably to MgBr₂. The samples were then washed with diethyl ether (2×10 ml) and sodium borohydride (0.050 g, 1.3 mmol) in ethanol (20 ml) added. This was then heated under reflux (80° C.) for 6 h before the samples were washed with methanol (4×10 ml) and 1-butanol (2×5 ml). 1-Butanol (10 ml), 1-iodooctane (150 μl, 1.03 mmol) and 2,2-azobisisobutyronitrile were then added and the reaction heated to 80° C. for 6 h. The reactions were then cooled in ice and the solutions filtered, the volume measured and the results analysed by gas chromatography. Samples were also sent for ICP (inductive coupling plasma) analysis to determine the degree of tin contamination.

TABLE 5
Resistance of PhSn((CH₂)₁₂)_{3/2} (11′) to degradation by bromine.

| Polymer | Mass, mmol | Br₂ in μl | % loss after Br₂ |
|---|---|---|---|
| B1 | 0.1186 g, 0.265 mmol | 11.4 | 8.67 |
| B2 | 0.1991 g, 0.444 mmol | 19.1 | 9.05 |
| B3 | 0.2813 g, 0.628 mmol | 27.0 | 9.88 |
| B4 | 0.1119 g, 0.250 mmol | 10.7 | 11.1 |
| B5 | 0.2227 g, 0.497 mmol | 21.4 | 12.2 |

It is clear from Table 5 that the resistance to chemical break down by bromine of this polymeric network is much superior over the network prepared from tin tetrachloride, that is converted to lightly cross-linked polymers upon treatment with bromine. This network retains its highly cross-linked structure by the selective cleavage of the Ph—Sn bonds by bromine over the backbone tin-carbon bonds.

TABLE 6
Activity of the polymeric tin hydride (12b).

| Polymer | Active tin as SnH in % | Active SnH in mmol g−1 |
|---|---|---|
| B1 | 40.0 | 1.08 |
| B2 | 45.3 | 1.22 |
| B3 | 60.7 | 1.63 |
| B4 | 46.6 | 1.25 |
| B5 | 27.6 | 0.74 |

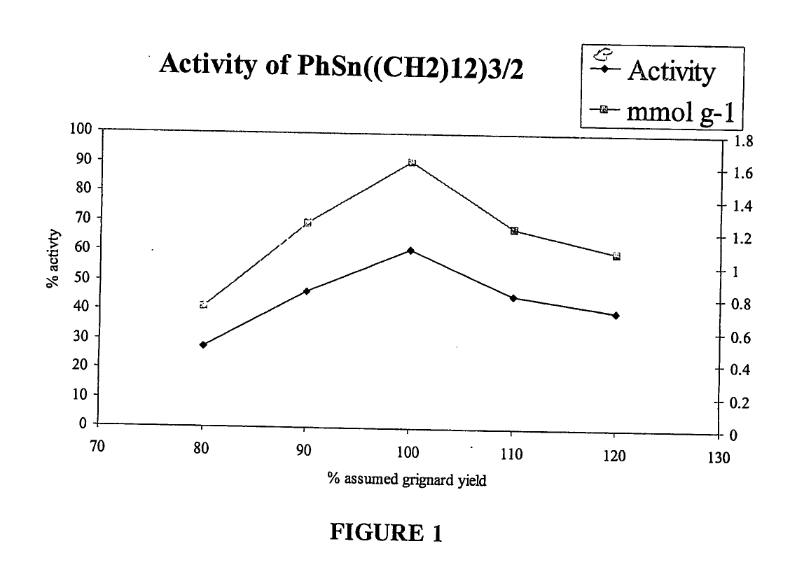

It can be seen from Table 6 that in the case of this polymeric network, the material that was found to be most active was that prepared by assuming a 100% yield of diGrignard. Due to the greater length of the hydrocarbon linker chain, the tin hydride loading is less than that observed for the polymers A3 to A5. This is summarised in FIG. 1.

Solid Tin Hydride Selectivity

Hydrogenation of 6-bromohexene to Methylcyclopentane

Approximately 1 g of previously used polymeric network in the form of SnI (ISn((CH₂)₁₂)_{3/2}) was regenerated to the tin hydride diisobutylaluminium hydride (20 wt % in toluene, used in excess) and washed with water and toluene. The hydride was characterised by infrared and proton NMR spectroscopy. To the dry hydride, 6-bromohexene (100 μl, 123 mg, 0.747 mmol) and isododecane (Avacado) (100 μl) as an internal standard, and 2,2-azobisisobutyronitrile (5.5 mg, ˜6 mol %) was added in toluene. The reaction was heated at 40° C. and samples taken periodically for analysis by gas chromatography.

Selectivity, Hexene 67.1%, methylcyclopentane 32.9%, final mass balance 96%.

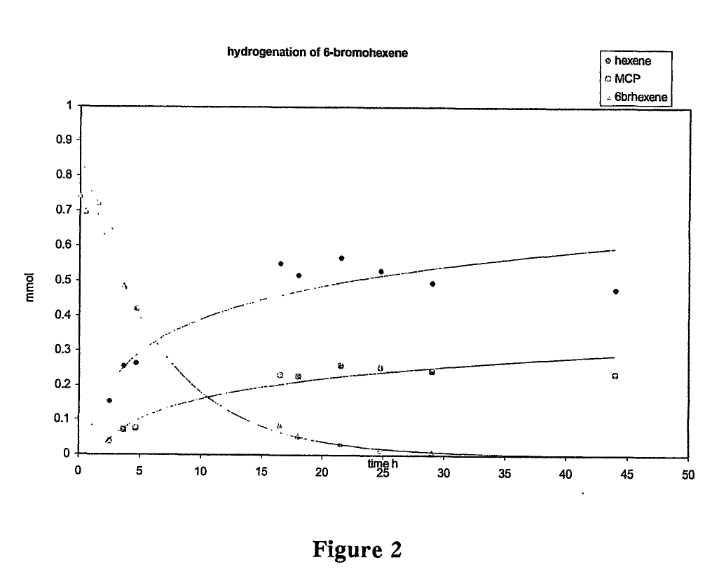

The conversion of the 6-bromo-1-hexene was excellent, no detectable level remaining at the end of the reaction. The selectivity was however not as good as that reported for tributyltin hydride under similar conditions. The hydride concentration in the solid network is too high to allow time for the free radical rearrangement to take place before the hydrogen transfer step. Essentially, Rₕ (rate of hydrogen transfer to the hexenyl radical) is too fast compared with Rᵣ (rate of intermolecular free radical rearrangement) due to the high concentration of tin hydride inside the material. These reactions are summarised in FIG. 2.

TABLE 7
Recycling of the Catalyst: Catalyst prepared by ‘method C’

| Cycle | Activity % | mmol g⁻¹ |
|---|---|---|
| 1 | 24.6 | 0.66 |
| 2 | 31.0 | 0.83 |
| 3 | 30.8 | 0.83 |
| 4 | 32.7 | 0.88 |
| 5 | 26.6 | 0.71 |

It can be seen from the data in Table 7 that the material prepared by ‘method C’ clearly does not deactivate over successive recycling. The activity is retained at around 30% active tin hydride.

TABLE 8
Leaching data of a material prepared by ‘method C’ obtained by ICP

| Cycle | Leaching as Mol % of total tin in catalyst |
|---|---|
| 1 | Nil |
| 2 | 0.00156 |
| 3 | Nil |
| 4 | Nil |
| 5 | Nil |

It can be seen from the data in Table 8 that the degree of tin leaching from this material is extremely low. The only tin contamination is believed to arise simply from the Mill Stone effect that is well documented.

Swelling Properties

A swelling study on a PhSn((CH₂)₁₂)_{3/2} (11′) network was performed on a materical prepared by ‘method C’, solvent was added to the polymeric network until the material was saturated, the weight of the material was recorded before and after the addition of solvent.

TABLE 9

| Solvent | Swelling g g−1 | Swelling ml g−1 |
|---|---|---|
| Chloroform | 7.71 | 5.17 |
| Toluene | 4.28 | 4.95 |
| Ether | 2.39 | 3.39 |
| Hexane | 1.87 | 2.84 |
| Methanol | 1.62 | 2.05 |
| Butanol | 1.44 | 1.78 |
| Dimethylformamide | 0.73 | 0.77 |

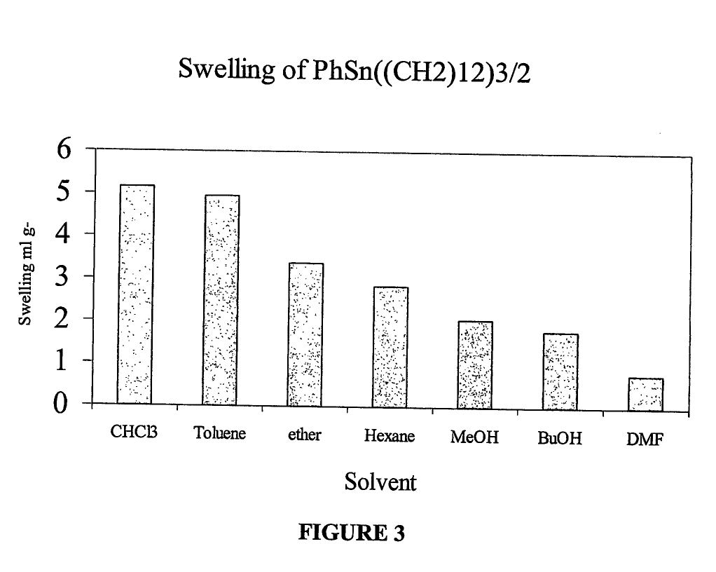

The results presented in Table 9 are for the catalyst precursor that contains a phenyl groups attached to the tin centres, the high swelling caused by toluene highlights this. The general trend is that the more hydrophobic solvents cause greater swelling of the network. The material remained white in the presence of all solvents except toluene and chloroform, in the presence of which the material become ‘gel-like’ and partially transparent. The swelling properties of PhSn((CH₂)₁₂)_{3/2}, are summarised in FIG. 3.

Variation of the Reflux Period During the Network Formation

PhSn((CH₂)₁₂)_{3/2} (11′) was prepared using a 1.67 times excess of diGrignard for each preparation and the diGrignard was added to the tin compound. The reflux time period was varied and the activities at a 1.38:1 Bromine to tin ratio were assessed.

TABLE 10

| Time | Tin utilisation as % | mmol g−1 | % loss |
|---|---|---|---|
| 24 | 69.0 | 1.28 | 10.4 |
| 16.3 | 47.0 | 0.87 | 9.9 |
| 4 | 43.2 | 0.80 | 16.7 |
| 1 | 36.6 | 0.68 | 9.1 |

The results in Table 10 clearly indicate that increasing the reflux time period increases the activity.

Varying the Ratio of Inorganic to Organic Components in PhSn((CH₂)₁₂)_{3/2} (11′)

The diGrignard of 1,12-dibromododecane was prepared in diethyl ether (15 ml) and stirred for 1 h, this was added to phenyltin trichloride in diethyl ether (5 ml) without stirring. The flash was shaken to mix the reagents before being heated under reflux for a period of 2 h. At the end of each reaction the material was cooled to room temperature and 2.0 molar hydrochloric acid added. Once the excess magnesium had dissolved the materials were filtered and washed with water and diethyl ether and then dried in a vacuum oven at 110° C.

TABLE 11
Tin compositions

| Assumed diGrignard | Tin loading in | Max Sn—H loading in |
|---|---|---|
| yield as % | mmol g-1 | mmol g-1 |
| 40 | 1.21 | 1.33 |
| 50 | 1.43 | 1.60 |
| 60 | 1.62 | 1.85 |
| 70 | 1.80 | 2.09 |

Assuming that the tin content in the solid is the same as the content of the respective precursors.

TABLE 12

| Assumed diGrignard | | Sn—H loading in mmol |
|---|---|---|
| yield as % | Tin utilisation as % | g-1 |
| 40 | 52 | 0.69 |
| 50 | 42 | 0.67 |
| 60 | 13 | 0.23 |
| 70 | 7.5 | 0.16 |

Table 12 shows that using greater excesses of the organic component of the networks was found to produce an material with a greater tin utilisation and subsequently higher loading of tin hydride.

### Example 5

Preparation of a Solid Organosilane Network

Method D, SiCl₄ and BrMg(CH₂)₁₂MgBr

The below detailed experiment was carried out with the aim of preparing an insoluble solid organosilane network containing unreacted silicon chloride groups that could be later reduced to give silicon hydride functions.

A 1.67 times excess of the diGrignard of 1,12-dibromododecane (3.00 g, 9.15 mmol and magnesium, 0.48 g, 2.0 mmol) was prepared in diethyl ether and added to silicon tetrachloride in diethyl ether at room temperature. Initially no reaction appeared to take place before a warming of the solution occurred. The reaction was heated under reflux at 55° C. and after about 1 h a white rubbery solid formed as small particles. After 16 h a polymeric white solid was evident, water was added and this reacted very exothermally, attempts to filter the solution caused filter blockage. The insoluble fraction was dried at 100° C. and became quite brittle and hard (white). This was washed in 2.0 molar hydrochloric acid and a little diethyl ether, and washed with water by filtration and with diethyl ether by decantation (3 times). This yielded a pale brown solid. The soluble fraction was evaporated to dryness in air and formed a very rubbery transparent solid. The solid obtained from the soluble fraction became mostly insoluble after drying suggesting formation of siloxane (Si—O—Si) cross-linking.

To the insoluble material (101.8 mg), bromine (11.5 μl) was added, this reacted very slowly with the silicon network. The network was filtered and treated with diisobutylaluminum hydride (0.75 ml, 20 wt % in toluene). This was then washed with toluene followed by hexane and the infrared and proton NMR spectra recorded.

Diisobutylaluminium hydride (0.75 ml, 20 wt % in toluene) was added directly to the insoluble solid organosilicon network (72.9 mg), the solid was then filtered and washed with toluene and diethyl ether before the material was dried in the atmosphere at room temperature and the infrared and proton NMR spectra recorded.

The infrared spectra of the materials prepared all expressed absorption peaks in the region expected for silicon hydrogen stretching mode absorption. Treatment of the insoluble material with bromine prior to reduction with diisobutylaluminium hydride appeared to have no effect on the amount of silane subsequently produced. The soluble material did however show a more intense silicon hydride signal in the infrared spectra. The soluble material showed a more intense silicon hydride signal in the infrared spectra. The presence of silane functions was also detected by proton NMR spectroscopy at 3.44 ppm, the silicon hydride triplet is observed at 3.7 ppm for tributylsilane.

### Example 6

Method E, HSiCl₃ and BrMg(CH₂)₁₂MgBr

A 1.67 times excess of diGrignard reagent was prepared from 1,12-dibromododecane (5.84 g, 17.8 mmol) and magnesium (0.94 g, 39.2 mmol). This was added to trichlorosilane (HSiCl₃, 0.964 g, 0.719 ml, 7.12 mmol) in diethyl ether. A violent reaction occurred as the diGrignard was added and a white material appeared immediately. The whole solution solidified into a partially white, partially transparent rubbery solid. This was then cooled to room temperature before 1 molar HCl (20 ml) was slowly added and the solid filtered and washed with water, ethanol and finally diethyl ether. Further diethyl ether was added and this was heated and reflux at 55° C. for 15 h. The diethyl ether was removed from the soluble fraction to yield white oil that could be re-dispersed into organic solvents.

### Example 7

Preparation of (MeHSi(CH₂)₁₂)ₙ (13) Polymers

A 1.67 times excess of diGrignard reagent was prepared from dibromododecane (5.16 g, 15.7 mmol) and magnesium (0.85 g, 35.4 mmol) in diethyl ether (20 ml). The diGrignard was slowly added to dichloromethylsilane (1.08 g, 9.39 mol) in diethyl ether (10 ml) at 0° C. This was then heated to 50° C. under reflux overnight before being cooled to 0° C. and 1.0 molar hydrochloric acid (20 ml) slowly added. The organic phase was separated and washed with water three times and dried over magnesium sulphate. The diethyl ether was removed by rotary evaporation to yield an oily polymer.

Materials analogous to the lead species tris-(trimethylsilyl)silane were investigated, the vital aspect of the lead compound is that the hydrogen carrying silicon atom is covalently bonded to three other silicon atoms. This allows for a unique interaction of the p-orbitals allowing a stabilisation of the corresponding tri-(trimethylsilyl)silyl radical by partial delocalisation of the unpaired electron. For this reason, the synthesis of materials in which each silicon carrying a hydrogen is connected to three other silicon atoms was studied. The first in this series of networks is the very simplest material, an interconnecting network of silicon wherein each silicon carries a hydrogen and is bonded to three neighbouring silicon atoms that also carry one hydrogen atom. The reduction of trichlorosilane by a metal species to give a silane network of the form (HSi)ₙ was proposed.

Preparation of (HSi)ₙ (14) Network

Magnesium (0.683 g, 28.5 mmol) was dried in a shlenk flask, this was treated with a small amount of iodine vapour before trichlorosilane (1.74 ml, 2.25 g, 16.6 mmol) was added in diethyl ether (5 ml). The solution was initially pale brown (iodine) but became clear and a white precipitate appeared, presumably magnesium chloride.

(¹H NMR spectrum, 4.86 ppm, S1H), (FT-IR spectrum, 2250 cm⁻¹, H—SiC₃ stretch, 2132 cm⁻¹, reduced trichlorosilane Si—H stretch), (Mass spectrum, 265, 309, 326, 351, 368, 385, 400, 418, H₇Si₇Cl₆₋ₙ(OH)ₙ n=0 to 4 and H₅Si₅Cl₅₋ₙ(OH)ₙ n=0 to 3)

The proton NMR spectrum expressed a peak at 4.86 ppm but also showed the presence of trichlorosilane at 7.48 ppm. The FT-IR spectrum showed two peaks, one at 2250 cm⁻¹ corresponding to trichlorosilane, and another at 2132 cm⁻¹ indicating a partial reduction of the trichlorosilane. The mass spectrum analysis revealed that the material contained H₇Si₇Cl₆₋ₙ(OH)ₙ n=0 to 4 and H₅Si₅Cl₅₋ₙ (OH)ₙ n=0 to 3. Partial reduction of the trichlorosilane occurs in this reaction, most probably due to the precipitation of the network as it forms. The reduction is expected to proceed readily initially as the trichlorosilane is a free species in the solvent, as the network begins to grow in size, unreduced silicon may become entrapped inside the bulk material. Once the network reaches a sufficient size that it begins to precipitate the reaction is very much hindered, at this stage both the magnesium and the partially reduced trichlorosilane are in the solid phase and the reaction rate is negligible. To overcome this problem a soluble metal reducing agent was employed, sodium naphthalenide was used to reduce the trichlorosilane.

Naphthalene (2.21 g, 17.3 mmol) was added to THF (30 ml, dry and degassed) in a 100 ml flask, this dissolved readily to give a clear solution. Sodium (0.79 g, 34.3 mmol) was wiped of excess oil and weighed before being cut into small pieces and added to the solution, after about 2 h the solution had become dark green. Trichlorosilane (0.44 ml, 0.56 g, 4.1 mmol) in THF (20 ml) was slowly added to the sodium naphthalenide solution. At first the solution became white as the solutions mixed but stirring removed this although a solid precipitate persisted. The reaction colour changes proceeded from dark green, dark brown, orange, yellow, to white. Sodium remained at the bottom of the flask and continued to react with the liberated naphthalene causing a colour change in the reverse order. This occurred over the course of two days.

TABLE 13
Infrared spectroscopy

| Absorption in | Literature absorption in | |
|---|---|---|
| cm⁻¹ | cm⁻¹ | Assignment |
| 2924 and 2845 | 2970 to 2930 and 2980 to | CH₂ and CH₃ |
| | 2845 | respectively |
| 2244 | 2258 | Trichlorosilane Si—H |
| | | stretch |
| 2111 | | (Me₃Si)₃Si—H type stretch |
| 1594 | 1594 | Naphthalene |
| 1462 and 1377 | 1470 to 1450 and 1380 to | Methylene units |
| | 1370 | |

The reduction of trichlorosilane by sodium naphthalenide is much more complete than when magnesium turnings are used. However the material produced in both preparations was a fine powder that did not settle readily and so from an application viewpoint materials prepared by this method are of little value since filtration would be a non-trivial procedure. The mechanism of this reduction is thought to proceed via a free radical mechanism, transfer of a single electron from the naphthalenide ainionic radical to the trichlorosilane is postulated as the first step. Loss of chloride from this species to give the dichlorosilane radical is expected followed by coupling of two of these radicals and continued reduction by single electron transfers. Interestingly, the naphthalene is able to return to the sodium whereby forming more sodium naphthalenide and thus acting catalytically.

1-45. (canceled)

46. A polymer comprising:
a structural unit (1) 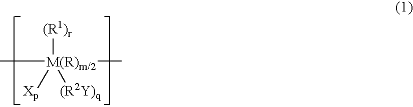
wherein R is individually selected from divalent hydrocarbon radicals;
R¹ is selected from the group consisting of monovalent hydrocarbon radicals, organic polymers and inorganic polymers;
R² is individually selected from divalent hydrocarbon radicals;
M is a tin, silicon or germanium atom, preferably tin or silicon, more preferably tin;
X is selected from H, Cl, Br and I;
Y is selected from H, Cl, Br and I;
m is an integer of 1 or 2;
p is an integer of 1 or 2;
q is an integer of 1 or 2;
r is an integer of 0 or 1; and,
wherein m+p+q+r=4, or
a structural unit (2) 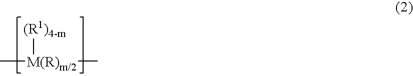
wherein R is individually selected from divalent hydrocarbon radicals;
R¹ is selected from the group consisting of monovalent hydrocarbon radicals, H, Cl, Br, I, organic polymers and inorganic polymers;
M is a tin, silicon or germanium atom, preferably tin or silicon, more preferably tin; and,
m is an integer of 1-4.

47. A polymer according to claim 46, wherein the polymer is a hydrogenation catalyst when X is H.

48. A polymer according to claim 46, comprising one or both of the following structures 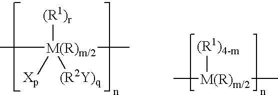
wherein n is an integer of 10-100000, more preferably 50-50000, more preferably 200-10000.

49. A polymer according to claim 46, wherein R is selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ alkarylenediyl and C₅₋₃₀ arylenediyl, any of which may be optionally substituted with one or more heteroatoms in the carbon backbone.

50. A polymer according to claim 46, wherein substantially all groups R are the same.

51. A polymer according to claim 46, wherein R¹ is selected from the group consisting of C₁₋₂₀ alkyl, C₁₋₂₀ alkoxy, C₂₋₂₀ alkenyl, C₂₋₂₀ alkynyl, C₃₋₃₀ cycloalkyl, C₃₋₃₀ cycloalkenyl, C₄₋₃₀ cycloalkynyl, C₇₋₃₀ alkaryl, C₅₋₃₀ aryl, C₅₋₃₀ aryloxy, any of which may be optionally substituted with one or more heteroatoms in the carbon backbone, organic and inorganic polymers.

52. A polymer according to claim 46, wherein R¹ is selected from the group consisting of methyl, ethyl, propyl, butyl, hexyl, cyclohexyl, octyl, nonyl, dodecyl, eicosyl, norbornyl and adamantyl, vinyl, propenyl and cyclohexenyl, benzyl, phenylethyl and phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl, biphenylyl, methoxy, ethoxy, propoxy, butoxy, pentoxy, hexoxy, phenoxy, 1,2-dimethylbutoxy, preferably phenyl and phenoxy.

53. A polymer according to claim 46, wherein R² is selected from the group consisting of C₁₋₂₀ alkanediyl, C₂₋₂₀ alkenediyl, C₂₋₂₀ alkynediyl, C₃₋₃₀ cycloalkanediyl, C₃₋₃₀ cycloalkenediyl, C₅₋₃₀ cycloalkynediyl, C₇₋₃₀ alkarylenediyl and C₅₋₃₀ arylenediyl, any of which may be optionally substituted with one or more heteroatoms in the carbon backbone.

54. A polymer according to claim 46, wherein X is individually selected from the group consisting of Br, I and H, most preferably Br and H.

55. A polymer according to claim 46, wherein Y is individually selected from the group consisting of Br, I and H, most preferably Br and H.

56. A polymer according to claim 46, wherein X′ is Cl.

57. A polymer according to claim 46, wherein p in structural unit (1) is 1.

58. A polymer according to claim 46, wherein q in structural unit (1) is 1.

59. A polymer according to claim 46 comprising structural unit (1), wherein the polymer comprises a structural unit (7) and/or (8) 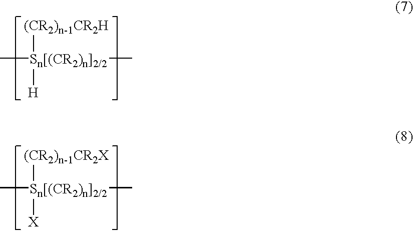
wherein R is individually selected from the group consisting of H, methyl and propyl, preferably H;
X is Br or I; and,
n is an integer of 1-20, preferably 1-12, more preferably 6, 8, 10, or 12.

60. A polymer according to claim 46 comprising structural unit (1), wherein the polymer comprises a structural unit (9) and/or (10) 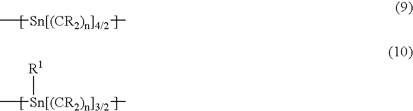
wherein R is individually selected from the group consisting of H, methyl and propyl, preferably H;
R¹ is selected from the group consisting of C₆₋₁₀ aryl and C₆₋₁₀ aryloxy, preferably phenyl and phenyloxy; and,
n is an integer of 1-20, preferably 1-12, more preferably 6, 8, 10, or 12.

61. A polymer according to claim 46, wherein the molecular weight of the polymer is in the range of 100-10000000, more preferably in the range of 1000-1000000, more preferably in the range 10000-100000.

62. A process for the production of a polymer comprising a structural unit (2) 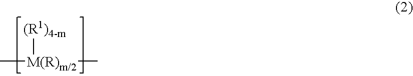
wherein R is individually selected from divalent hydrocarbon radicals;
R¹ is selected from the group consisting of monovalent hydrocarbon radicals, H, Cl, Br, I, organic polymers and inorganic polymers;
M is a tin, silicon or germanium atom, preferably tin or silicon, more preferably tin; and,
m is an integer of 1-4; comprising reacting a diGrignard reagent having the formula (3)
XM′(R)M′X (3)
wherein X is individually selected from the group consisting of Cl, Br and I;
M′ is individually selected from the group consisting of Group II metals; and,
R is selected from divalent hydrocarbon radicals;
with a compound having the formula (4)
R¹ₐMX′_{b} (4)
wherein R¹ is selected from the group consisting of monovalent hydrocarbon radicals, H, organic polymers and inorganic polymers;
M is a tin, silicon or germanium atom, preferably tin or silicon, more preferably tin;
X is individually selected from the group consisting of Cl, Br and I;
X′ is individually selected from the group consisting of Cl, Br and I;
a is an integer of 0-2; and,
b is an integer of 2-4.

63. A process for the production of a polymer comprising a structural unit (1) 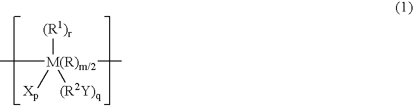
wherein R is individually selected from divalent hydrocarbon radicals;
R¹ is selected from the group consisting of monovalent hydrocarbon radicals, organic polymers and inorganic polymers;
R² is individually selected from divalent hydrocarbon radicals;
M is a tin, silicon or germanium atom, preferably tin or silicon, more preferably tin;
X is selected from Cl, Br and I;
Y is selected from Cl, Br and I;
m is an integer of 1 or 2;
p is an integer of 1 or 2;
q is an integer of 1 or 2;
r is an integer of 0 or 1; and,
wherein m+p+q+r=4; comprising reacting a compound having formula (2) as defined in claim 69 with a compound selected from a chlorinating agent, a brominating agent and an iodinating agent.

64. A process for the production of a polymer comprising a structural unit (1) 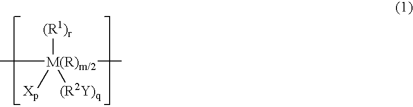
wherein R is individually selected from divalent hydrocarbon radicals;
R¹ is selected from the group consisting of monovalent hydrocarbon radicals, organic polymers and inorganic polymers;
R² is individually selected from divalent hydrocarbon radicals;
M is a tin, silicon or germanium atom, preferably tin or silicon, more preferably tin;
X is selected from H, Cl, Br and I;
Y is selected from H, Cl, Br and I; with the proviso that at least one of X or Y is H;
m is an integer of 1 or 2;
p is an integer of 1 or 2;
q is an integer of 1 or 2;
r is an integer of 0 or 1; and,
wherein m+p+q+r=4; comprising reacting a polymer comprising a structural unit (1),
wherein X and Y are selected from Cl, Br and I, with a reducing agent that is a hydride source.

65. A process according to claim 62, wherein M′ is selected from magnesium or calcium, most preferably magnesium.

66. A process according to claim 62, wherein a is 0 or 1.

67. A process according to claim 62, wherein b is preferably 3 or 4.

68. A process according to claim 63, wherein the chlorinating, brominating and iodinating agents are Cl₂, Br₂, 12 respectively.

69. A process according to claim 64, wherein the reducing agent is selected from the group consisting of borohydrides, aluminium hydrides and/or boranes; preferably lithium aluminium hydride, sodium borohydride, sodium hydride, boranes, selectride, lithium borohydride, sodium cyanoborohydride, sodium naphthelenide, DIBAL-H and/or REDAL-H.

70. A process according to claim 64, wherein the reduction reaction is facilitated with a radical initiator, preferably selected from the group consisting of 2,2′-azobisisobutyrpnitrile (AIBN), benzoyl peroxide, tert-butyl peracetate, peracetic acid, tert-amyl peroxybenzoate, tert-butylperoxide and cyclohexanone peroxide.

71. A process for the production of a polymer comprising a structural unit (1) 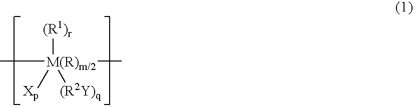
wherein R is individually selected from divalent hydrocarbon radicals;
R¹ is selected from the group consisting of monovalent hydrocarbon radicals, organic polymers and inorganic polymers;
R² is individually selected from divalent hydrocarbon radicals;
M is a tin, silicon or germanium atom, preferably tin or silicon, more preferably tin;
X is selected from H, Cl, Br and I;
Y is selected from H, Cl, Br and I; with the proviso that at least one of X or Y is H;
m is an integer of 1 or 2;
p is an integer of 1 or 2;
q is an integer of 1 or 2;
r is an integer of 0 or 1; and,
wherein m+p+q+r=4, comprising the steps of:
(i) reacting a diGrignard reagent having the formula (3)
XM′(R)M′X (3)
wherein X is individually selected from the group consisting of Cl, Br and I;
M′ is individually selected from the group consisting of Group II metals; and,
R is selected from divalent hydrocarbon radicals;
with a compound having the formula (4)
R¹ₐMX′_{b} (4)
wherein R¹ is selected from the group consisting of monovalent hydrocarbon radicals, H, organic polymers and inorganic polymers;
M is a tin, silicon or germanium atom, preferably tin or silicon, more preferably tin;
X is individually selected from the group consisting of Cl, Br and I;
X′ is individually selected from the group consisting of Cl, Br and I;
a is an integer of 0-2; and,
b is an integer of 2-4;
(ii) reacting the product of step (i) with a compound selected from a chlorinating agent, a brominating agent and an iodinating agent; and,
(iii) reacting the product of step (iii) with a reducing agent that is a hydride source.

72. A polymer comprising the structural unit (5)
(HSi)ₙ (5)
wherein n is an integer.

73. A polymer according to claim 72, wherein n is an integer of 3-1000000, preferably 10-100000, more preferably 50-50000, most preferably 200-10000.

74. A process for the production of a polymer comprising a structural unit (5)
(HSi)ₙ (5)
wherein n is an integer;
comprising reducing a compound having the formula (6)
HSiX″₃ (6)
wherein X″ is individually selected from the group consisting of Cl, Br and I.

75. A process according to claim 74, wherein the reducing agent is an ionic metal-containing compound.

76. A process according to claim 75, wherein the reducing agent is an ionic metal-hydrocarbon pair.

77. A process according to claim 75, wherein the reducing agent is selected from the group consisting of ionic Group I, II, XI and XIII metal-hydrocarbon compounds.

78. A process according to claim 77, wherein the metal is selected from the group consisting of Li, Na, K, Mg, Ca, Cu, Hg and Zn.

79. A process according to claim 77, wherein the hydrocarbon is selected from the group consisting of cyclohexenyl, benzyl, phenylethyl and phenylpropyl, phenyl, tolyl, dimethylphenyl, trimethylphenyl, ethylphenyl, propylphenyl, biphenyl, naphthyl, methylnaphthyl, anthryl, phenanthryl, benzylphenyl, pyrenyl, acenaphthyl, phenalenyl, aceanthrylenyl, tetrahydronaphthyl, indanyl and biphenylyl anions.

80. A process according to claim 74, wherein the reducing agent is sodium naphthalenide.
